(19) United States
(12) Patent Application Publication
(10) Pub. No.: US 2003/0004986 A1
(43) Pub. Date: Jan. 2, 2003

(54) Word processing management method with multiple I/O modes

(76) Inventors: Kuang-Shin Lin, Taipei (TW); Sayling Wen, Taipei (TW); Xiao-Yu Long, Tianjin (CN)

Correspondence Address: BIRCH STEWART KOLASCH & BIRCH, PO BOX 747, FALLS CHURCH, VA, 22040-0747, US

(21) Appl. No.: 10/183,555

(22) Filed: Jun. 28, 2002

(30) Foreign Application Priority Data
Jun. 29, 2001 (TW) 90115895

(51) Int. Cl. G06F 15/00

(52) U.S. Cl. 707/500

(57) ABSTRACT

A word processing management method with multiple I/O modes is disclosed by the invention. It is a utility under an OS that can operate with other different OS's. The user can complete a desired task through a single action using the UOI provided by the invention. The invention achieves word editing and processing management through multiple input and output modes. The invention includes the steps of: opening a word document file, selecting an input method for further processing, loading the word document file and selecting an output method to output the word document file.

### BACKGROUND OF THE INVENTION

1. Field of the Invention

The invention relates to an OS (Operating System) and, in particular, to a word processing management method that can operate with other different OS's and has multiple I/O (Inputs/Outputs) modes.

2. Related Art

With the increase in computer popularity, people often need to use computers to solve problems either at work or at home. But there are some causes that still produce the difficulty for people to use computer especially in the input and output modes of word processing. One can see the causes in the following points:

1. Existing personal computer OS's (Operating Systems), such as MS Windows, Linux, and so on, are complicated despite their powerful functions and designs. Moreover, the user operation designs are not intuitive and simple enough. This situation scares people without any computer background because of the obstacles they meet while using these systems.

2. The word processing software has a unique input method, which is not intuitive and simple enough to directly output edited contents to fax, E-mail, printers, and other communications devices. When a user is not familiar with the format, it also takes much time to fully understand.

Because of the above, it is thus highly desirable to provide a simple and convenient OS with multiple I/O modes to solve these problems.

### SUMMARY OF THE INVENTION

In view of the foregoing, the invention provides a word processing management method with multiple input and output modes. The method is based on a one-touch OS, the main objective of which is to use a finite number of keys as hot keys to achieve the operation of various functions. In this OS, each function is initiated by a single key, thus implementing convenience and intuition of operation and increasing users' interest in using computers.

A user can use one key to select multiple input methods for editing, e.g. template input means, self-defined input means, or voice input means. Using this method, the user can edit word document with a format that he is not familiar with. The user can edit the word document by voice and typing. Regarding output, the method allows the edited contents to be sent to fax, E-mail, and printers. There is no complicated operating interface that perplexes the user.

In light of the foregoing advantages, any computer on which the multiple I/O (Input/Output) word processing management method is installed allows users to obtain extra value and advantages in obtaining data, thus facilitating sales and uses of computers.

The invention includes the steps of: opening a word document file, selecting an input means for further processing, loading the word document file and selecting an output means to output the word document file.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 is a flowchart of the disclosed multiple I/O word processing management method;

FIG. 2-a is a flowchart of editing in FIG. 1;

FIG. 2-b is a flowchart of input in FIG. 1;

FIG. 2-c is a flowchart of output in FIG. 1; and

FIG. 3 is a schematic view showing the main interface of the invention.

### DETAILED DESCRIPTION OF THE INVENTION

The invention proposes a multiple I/O word processing method. In contrast to currently complicated OS's (Operating Systems), the invention provides a convenient and intuitive UOI (User Operating Interface). The user can complete any desired effect by hitting a single key (hot key) on a keyboard. By linking to the network, the user can perform multiple I/O methods to edit word documents using the one-touch OS.

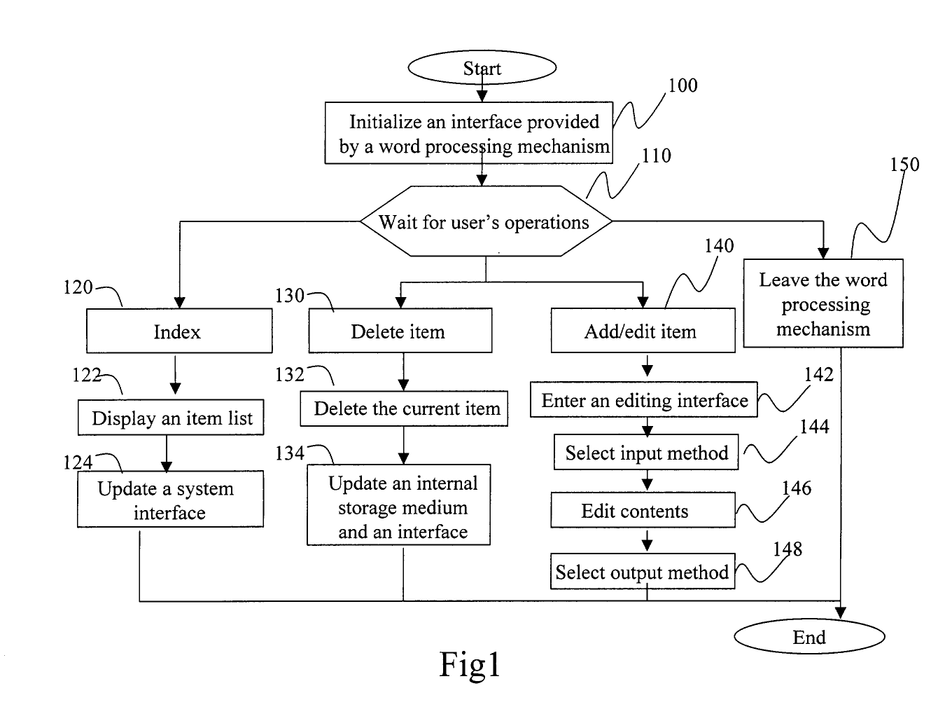

A preferred embodiment of the invention is shown in FIG. 1. First, the one-touch OS 50 initiates an interface provided by a word processing mechanism (step 100). The system then awaits the operation of a user (step 110). The user sends commands through a UOI 20. There are four types of commands, namely, index (step 120), delete item (step 130), add/edit item (step 140), and exit (step 150). The index command (step 120) allows users to enter a single letter, such as A˜Z and 1˜9, to search for specific item names to help the user's operations. Step 122 lists the items and step 124 updates the system interface. The system then enters the item selected by the user and finishes the sub-process. The delete item command (step 130) allows a user to delete an existing item in the internal storage medium 10 of the computer. The system deletes the item in step 132 and then updates the internal storage medium 10 and the interface in step 134. The add/edit item command (step 140) adds a new item to the internal storage medium and selects an existing item from the internal storage medium 10 for editing. Afterwards, the system enters an editing interface in step 142. The user selects an input method in step 144, then starts editing the contents in step 146 and selects an output method in step 148. The detailed contents of step 140 will be further explained below. The exit command (step 150) allows the user to leave the system.

The one-touch OS 50 refers to an OS that enables a user to complete a function provided in the work group displayed in the UOI 20 in one action. The work group is comprised of at least one function item. The one-touch OS 50 can operate with other different OS's or alone. The user chooses to switch among the different OS's.

The one-touch OS 50 can run on any computer controlled hardware platform, such as a PC (Personal Computer), an NB (Notebook), or a PDA (Personal Digital Assistant). Any person skilled in the art can make various modifications and implement the disclosed multiple I/O word processing management method in any electronic device that can connect to a network.

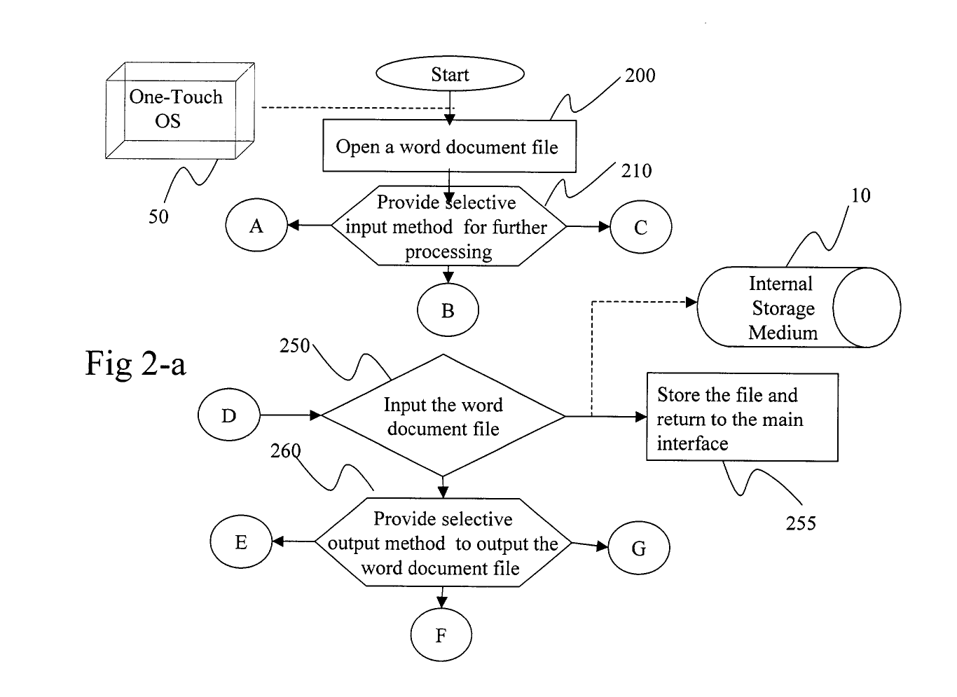

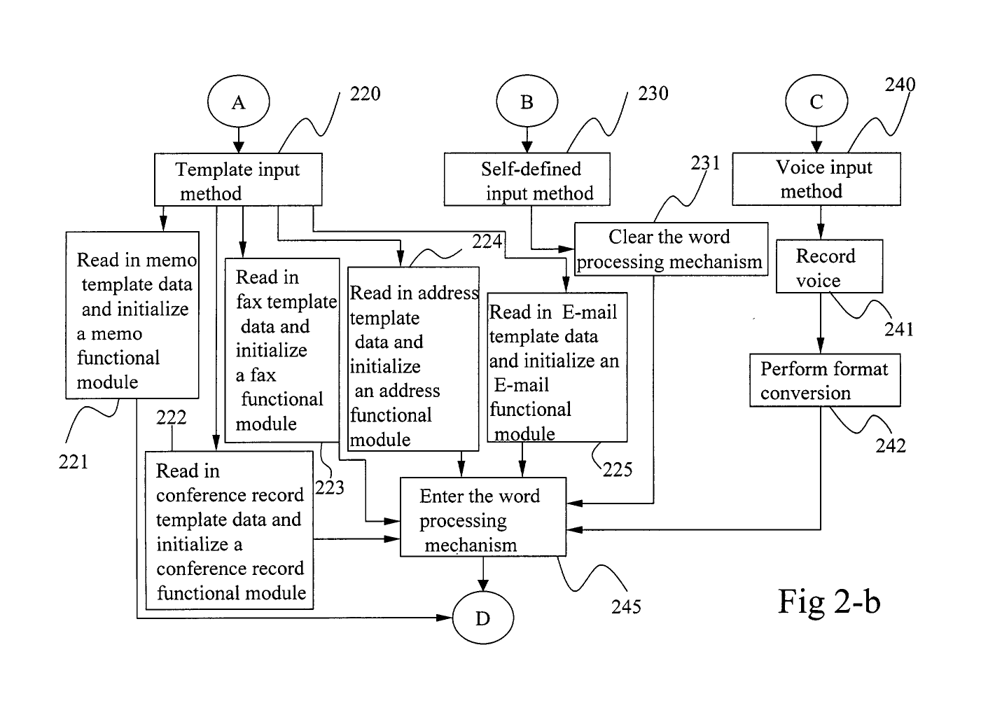

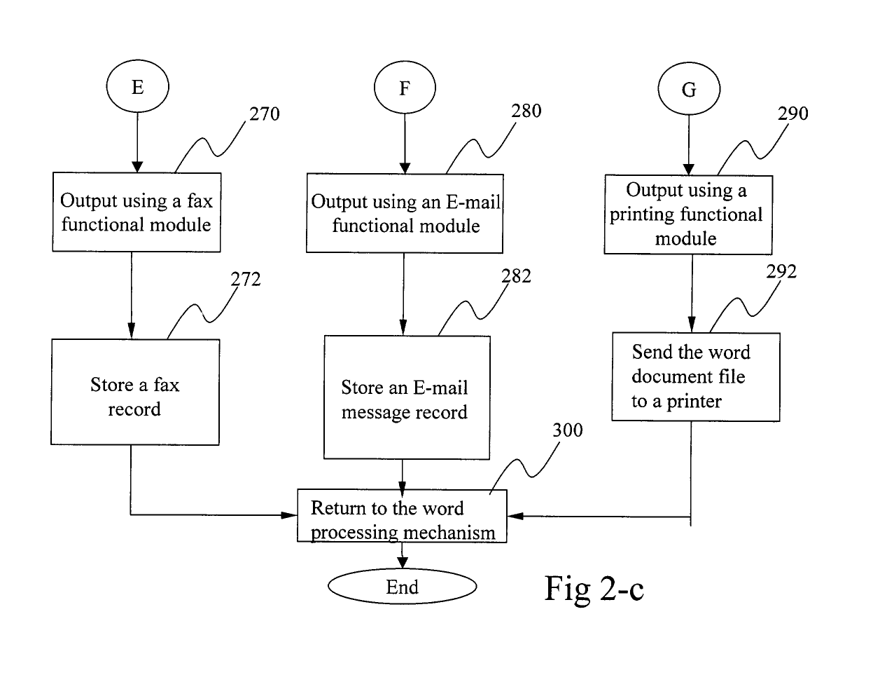

As shown in FIG. 2-a, the user can use the disclosed method to edit a document. First, the user enters the one-touch OS 50 and opens a word document file using the UOI 20 (step 200). If the file is an existing file in the internal storage medium 10, then the user can choose to directly output the file or to continue editing the file. If it is a newly created word document file, the selective input means are provided for further processing (step 210), followed by step A, B or C. With reference to FIG. 2-b, after entering step A the user can select a template input method (step 220), which includes the following five methods. Step 221 reads in memo template data and initializes the memo template. Step 222 reads in conference record template data and initializes the conference record template. Step 224 reads in address template data and initializes the address template. Step 225 reads in E-mail template data and initializes the E-mail template. After completing the above steps, step 245 enters the word processing mechanism, followed by step D. The memo template data are a specific format extracted from a memo functional module for processing user's personal business. The conference record template data are a specific format extracted from a conference record functional module for processing user's work conference contents. The fax template data are a specific format extracted from a fax functional module for processing user's fax files. The address template data are a specific format extracted from an address functional module for processing all address files. The E-mail template data are a specific format extracted from an E-mail functional module for processing E-mail files.

The above-mentioned five methods are predetermined formats in the word processing mechanism. Only when the user has the needs will they be used to save the user's time.

After step B, the user can select a self-defined input method (step 230). Step 231 clears the word processing mechanism. Step 245 enters the word processing mechanism, followed by step D.

After step C, the user can select a voice input method (step 240) to record his or her voice (step 241). Afterwards, the format is converted in step 242 to convert the voice file into text and present it in a word document file. Step 245 then enters the word processing mechanism, followed by step D.

Returning to FIG. 2-a, after step D step 250 processes the input of the word document file. If the user decides not to output the file, then the file is stored and the system returns to the main interface (step 255). The word document file is stored in the internal storage medium 10. If the user decides to output the file, then the system provides selective output methods for outputting the file (step 260), followed by step E, F, or G. With reference to FIG. 2-c, after step E step 270 outputs the file using a fax functional module. Afterwards, the fax record is stored (step 272). Finally, step 300 returns to the word processing mechanism.

After step F, step 280 outputs the file using an E-mail functional module. Step 282 stores the E-mail message record. After the word document file is sent by E-mail, step 300 returns to the word processing mechanism.

After step G, step 290 outputs the file using a printing functional module. Step 292 sends the file to a printer. After the word document file is printed, step 300 returns to the word processing mechanism.

The printing functional module, the E-mail functional module, the fax functional module, the memo functional module, the conference record functional module, and the address functional module are provided by the one-touch OS 50. Each of these functions can be started by a single action. The user can click the function he needs on the menu with hints provided by the UOI 20.

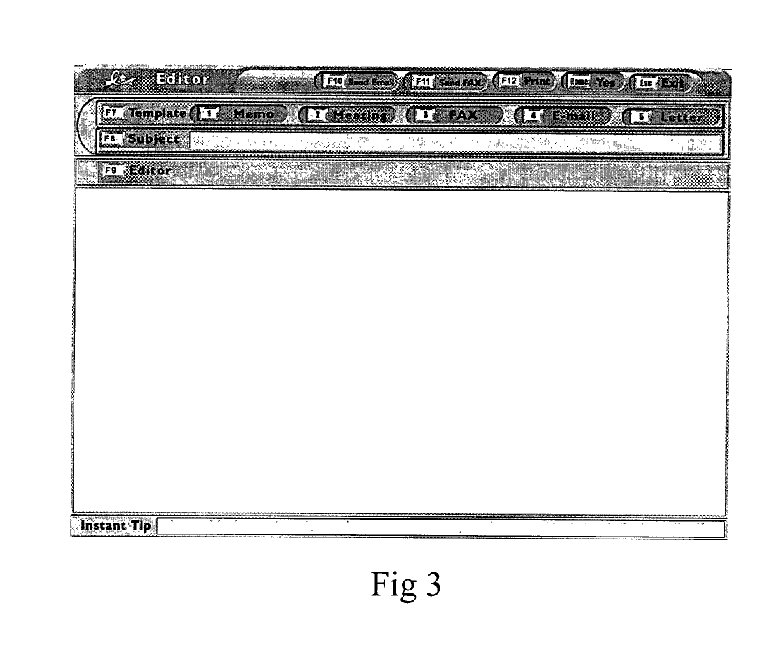

As shown in FIG. 3, the user enters a main interface window of the word processing mechanism and completes a desired job with the hints provided in the interface. In accordance with a preferred embodiment of the invention, the menu allows the user to select the memo functional module by clicking the key “1”, or the fax functional module by clicking the key “3”, etc. The user can also perform specific functions with the function keys. In other words, the user does not need to perform extra system settings and file saving actions. By simply clicking a single key, the user can perform a specific job. Therefore, the user can use the services provided by the computer in a more intuitive way, increasing the user's interest in using computers.

As described above, the user can perform a desired job through a single action and the UOI provides at least one hint menu for the user to follow to perform the correct single action. In the current embodiment, the single action function of the one-touch OS 50 allows the user 10 to directly hit one key on the keyboard according to a selection menu to enter his or her request. Any key on the keyboard can be set to complete this kind of action. The keys include the number keys 0˜9, the letter keys A˜Z, the function keys F1˜F12 and special keys ESC, TAB, PgUp, END, etc. Aside from the keyboard, the single action request input can be accomplished using a mouse or other controllers, such as the digital touch-control panel and the voice recognition system. That is, any basic input device for the computer can be used to provide one-touch control.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multiple I/O (Input/Output) word processing management method used in a one-touch OS running on a computer controlled hardware for a user to process word documents through a UOI (User Operating Interface) and monitored by a word processing mechanism, the method comprising:
opening a word document file;
providing selective input means for further processing;
inputting the word document file; and
providing selective output means to output the word document file.

2. The method of claim 1, wherein the one-touch OS is an OS that enables a user to complete a function provided in the work group displayed in an interface generating module in one action.

3. The method of claim 2, wherein the work group is comprised of at least one function item.

4. The method of claim 2, wherein the single action refers to the action that the user follows a selection menu generated by the UOI to perform controls using a basic I/O (Input/Output) device provided by the computer controlled hardware platform.

5. The method of claim 4, wherein the basic I/O device is selected from the group consisting of a keyboard, a mouse, a digital touch-control panel and a voice recognition system.

6. The method of claim 2, wherein the UOI generates at least one set of the work group.

7. The method of claim 1, wherein the one-touch OS is able to operate with other different OS's and the user determines to switch among the different OS's.

8. The method of claim 1, wherein the one-touch OS operates alone.

9. The method of claim 1, wherein the computer controlled hardware platform is selected from the group consisting of a PC (Personal Computer), an NB (Notebook), and a PDA (Personal Digital Assistant).

10. The method of claim 1, wherein the step of opening a word document file retrieves an existing work document file stored in an internal storage medium for the user to edit the word document file.

11. The method of claim 1, wherein the step of providing selective input means for further processing includes a template input means, a self-defined input means, and a voice input means.

12. The method of claim 11, wherein the template input means includes the steps of:
reading data of a specific template;
initializing the data of the specific template; and
applying the template in the word processing mechanism.

13. The method of claim 11, wherein the self-defined input means includes the steps of:
clearing the word processing mechanism; and
the user's arbitrary input to the word processing mechanism.

14. The method of claim 11, wherein the voice input means includes the steps of:
recording voice from the user; and
performing a format conversion using the word processing mechanism.

15. The method of claim 1, wherein the step of providing selective output means to output the word document file further includes a fax functional means, an E-mail functional means and a printing functional means.

16. The method of claim 15, wherein the fax functional means includes the steps of:
outputting the word document file through a fax functional module;
storing a fax record; and
returning to the word processing mechanism.

17. The method of claim 15, wherein the E-mail functional means includes the steps of:
outputting the word document using an E-mail functional module;
storing an E-mail message record; and
returning to the word processing mechanism.

18. The method of claim 15, wherein the printing functional means includes the steps of:
outputting the word document file using a typing functional module;
transmitting the word document file to a printer; and
returning to the word processing mechanism.

19. The method of claim 15, wherein the fax functional means, the E-mail functional means and the printing functional means are provided by the one-touch OS.
